(19) United States
(12) Patent Application Publication
(10) Pub. No.: US 2008/0235683 A1
(43) Pub. Date: Sep. 25, 2008

(54) Data Processing System And Method

(75) Inventor: Chandrika Malurpatna Sreedhar, Bangalore Kamataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett Packard Development Co, L.P., Houston, TX (US)

(21) Appl. No.: 12/052,667

(22) Filed: Mar. 20, 2008

(30) Foreign Application Priority Data
Mar. 21, 2007 (IN) 575/CHE/2007

(51) Int. Cl. G06F 9/44

(52) U.S. Cl. 718/100

(57) ABSTRACT

A method of producing a compartment specification for an application, the method comprising executing the application; determining resource requests made by the executing application; and recording the resource requests in the compartment specification.

### RELATED APPLICATIONS

This patent application claims priority to Indian patent application serial no. 575/CHE/2007, having title “Data Processing System and Method”, filed in India on 21 Mar. 2007, commonly assigned herewith, and hereby incorporated by reference.

### BACKGROUND TO THE INVENTION

Businesses across the globe are faced with rapidly changing, sophisticated attacks against their IT infrastructure. Managing security in large organizations with several hundred servers can be a challenge. To help businesses combat increasingly complex threats of attackers, operating system vendors have introduced compartmentalization. Similar to the design of a submarine, compartments are logical partitions to provide isolation between applications and resources, to prevent catastrophic damage should one of them be penetrated. When configured in a secure compartment, an application has restricted access to the resources as specified in a compartment specification associated with the application. The compartmentalization software enforces the restriction in particular by ensuring an application cannot access system resources in a way not permitted by the compartment specification. The set of restrictions is often referred to as a “compartment” within which an application is said to be executing. The secure compartment provides greater security for an application when compared to an application executing outside of a secure compartment, as the application executing outside of the secure compartment may have unrestricted access to all system resources, provided that the resources are available.

When an application makes a request for a resource that is not specified in its compartment specification, the resource request is denied. Therefore, if the application has been compromised, for example by an external attacker, the application cannot be used by the attacker to access any resources not specified in the compartment specification for the application.

The compartment specification must list all possible resource requests that may be made by the application so that the application has full functionality when it executes within the compartment. The compartment specification is produced manually by, for example, a system administrator, who may require knowledge of the application and the data processing system on which it will execute, and the operating system of the data processing system.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying drawings, in which:

FIG. 1 shows an example of a system for executing an application in a secure compartment;

FIG. 2 shows an example of a method according to embodiments of the invention;

FIG. 3 shows an example of a system for producing a compartment specification according to embodiments of the invention; and

FIG. 4 shows an example of a data processing system suitable for implementing embodiments of the invention.

### DETAILED DESCRIPTION OF EMBODIMENTS OF THE INVENTION

Embodiments of the invention can be used to automatically produce a compartment specification for an application, so that the application can subsequently execute in a secure compartment according to the compartment specification. Manually producing the compartment specification may lead to errors being introduced into the specification and may also require detailed knowledge of the application, the data processing system on which the application will execute, and the operating system of the data processing system. Furthermore, particularly for large and complex applications, some functionality may be missed from the compartment specification, leading to reduced functionality of the application when executed in a compartment, and a large amount of time may be required to generate the specification. Automatically generating the compartment specification may reduce or eliminate at least some of these problems.

The compartment specification and secure compartment may be used to protect against attacks on a system using an application executing in the secure compartment. For example, a vulnerability in an application such as a buffer overflow may be exploited by an attacker to execute code. The attacker may then attempt to access system resources to use or disable the resource. However, the secure compartment would not allow the attacker to access system resources except those resources and ways of accessing the resources specified in the compartment specification.

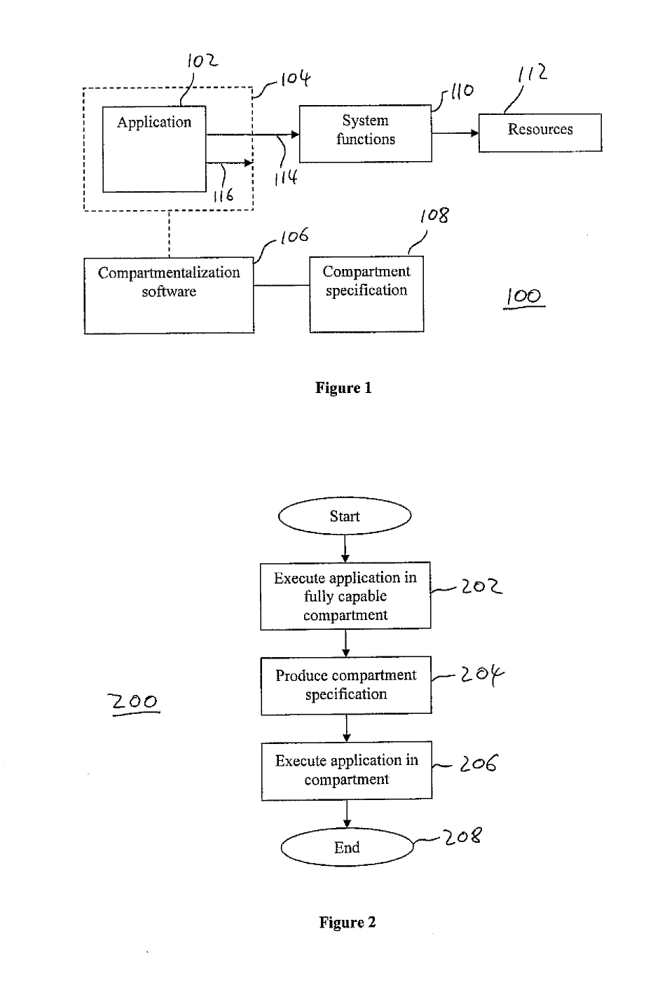

FIG. 1 shows a system 100 for executing an application 102 in a secure compartment 104. The compartment 104 is provided by compartmentalization software 106. The compartmentalization software 106 may provide any number of compartments, each containing an application. The application 102 is associated with a compartment specification 108, which includes a list of the resource requests permitted by the application 102. Different applications may be associated with different compartment specifications.

The compartmentalization software 106 may comprise, for example, Security Containment software that can be used with the HP-UX operating system, or Type Enforcement that can be used with the SELinux (Security Enhanced Linux) operating system. However, in alternative embodiments, other compartmentalization software and/or other operating systems may be used. The compartmentalization software 106 may be supplied with or as part of an operating system, or supplied separately.

The application 102 makes a resource request by calling a system function 110. The compartmentalization software 106 detects calls to the system functions 110 and determines whether the resource request is permitted by consulting the compartment specification 108 associated with the application 102. If the resource request is permitted, as indicated by the compartment specification 108, then the compartmentalization software 106 allows the application 102 to call the appropriate system function 110. The system functions 110 handle the resource requests and provisioning of the resources 112 to the application 102.

For example, the compartmentalization software 106 may detect a call 114 to a system function 110 and consult the compartment specification 108 to determine whether the resource requested in the call to the system function 110 is permitted. If it is permitted, then the application 102 will successfully call a system function 110, which will handle the resource request.

If the application 102 makes a resource request that is not permitted then the compartmentalization software 106 will prevent the call 116 to the system function 110 from being successful. Thus, the application 102 is prevented from making resource requests that are not permitted. The compartmentalization software may return to the application indicating that an error has occurred, for example that the resource request was unsuccessful or that the request was not permitted. A resource request that is not permitted is not indicated as permitted in the compartment specification, and/or is indicated as not permitted in the compartment specification.

A resource request may be made by an application for a resource that is available on or to a data processing system on which the application is executing. Resources may include, for example, file system objects such as files and directories, inter-process communication objects that enable an application to communicate with other applications, network communications resources that allow the application to communicate with other systems over a network, and ports in a data processing system. A resource request is a request to interact with a resource. Therefore, for example, where a resource is a data file on a file system, an application may make a resource request to read from the file or write to the file, and where a resource is a port, the application may make a resource request to bind with the port.

The execution of applications in secure compartments enhances the security of the applications and/or the data processing system on which they are executing, and/or the operating system on the data processing system. This is because the applications are prevented from interacting with resources and each other in unexpected ways. For example, if an application was compromised by a remote attacker, the remote attacker could not use the compromised application to attack the system as the application would be prevented from exhibiting unexpected behavior by the compartmentalization software. More specifically, the remote attacker cannot use the application to access resources in a way that is not specified in the compartment specification for the application.

FIG. 2 shows an example of a method 200 of producing a compartment specification according to embodiments of the invention. The method 200 starts at step 202 where the application is executed in a fully capable compartment. A fully capable compartment is a compartment that allows access to all resources. The compartmentalization software will not block any resource requests made from inside the fully capable compartment. Next, in step 204, the compartment specification is automatically produced as indicated in more detail below. Once the compartment specification has been produced in step 204, the method 200 in step 206 may cause the application to be executed in a secure compartment according to the compartment specification produced in step 204. That is, the application will only be permitted to make resource requests that were made while the compartment specification was being produced in step 204. Once the application is executing in a secure compartment, the method 200 ends at step 208.

The fully capable compartment may be provided by compartmentalization software for execution of certain applications on a data processing system. For example, some system applications may require access to many resources on a data processing system and are therefore executed in the fully capable compartment to avoid the need for a large, complex compartment specification. These system applications may include, for example, inetd, which monitors internet ports on Unix-based systems, and the swapper, which handles memory allocation for processes and influences CPU allocation on Unix-based systems.

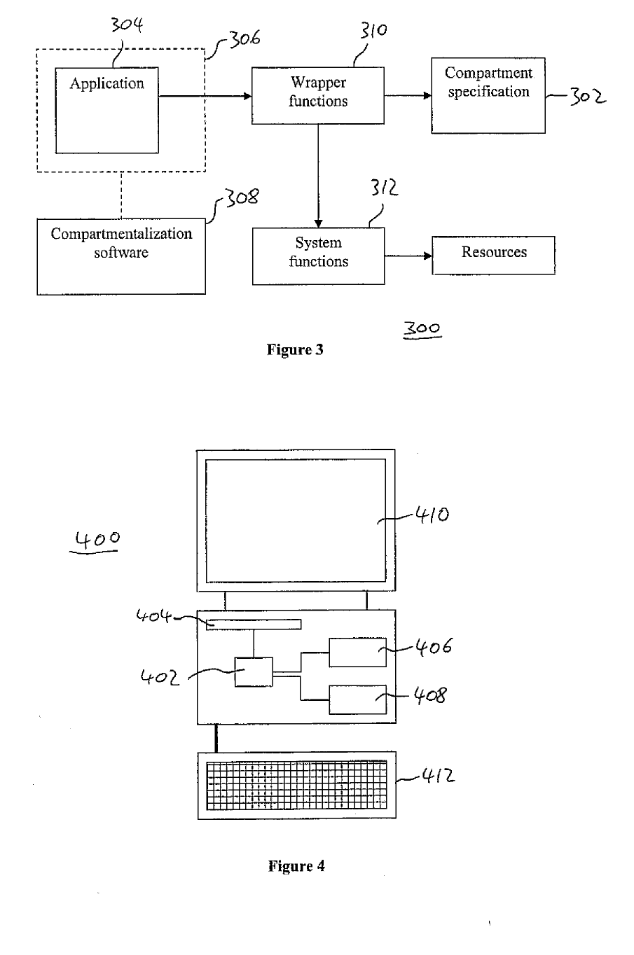

FIG. 3 shows an example of a system 300 for producing the compartment specification 302 according to embodiments of the invention. The application 304 is executing in a fully capable compartment 306, provided by compartmentalization software 308. When the application makes a resource request, it makes a call to a system function. However, a wrapper function 310 in a wrapper library (not shown) is called instead of the system function. The wrapper library is loaded, for example, when or before the application 304 began executing in the fully capable compartment 306, or when a wrapper function is called. The wrapper functions 310 are secondary definitions of system functions. Therefore, the wrapper functions 310 are called instead of the system functions 312 in a way that is transparent to the application 304. Thus, for example, the application does not require additional programming to be used within the system 300. For example, where the application 304 is being executed on a data processing system that includes the HP-UX operating system, the HP-UX operating system provides the functionality to load the wrapper library such that the functions within the wrapper library are called in place of the system functions, although the wrapper library may choose to call the system functions.

Examples of system functions for which wrapper functions may be provided include “mep_open”, “semget”, “shm_open”, “shmget” and “msgget” for inter-process communication, “create”, “open”, “mkdir” and “unlink” for file system access, and “socket”, “bind” and “connect” for network communications. These and other system functions may be provided by the HP-UX operating system, although embodiments of the invention may be used with other operating systems (such as, for example, Linux and/or Microsoft Windows) that provide their own system functions and/or ways of using wrapper functions in place of the system functions.

The application 304 may be a process or a thread, or a number of processes and/or threads. The application 304 may be executing before it is moved into the fully capable compartment 306, or it may start executing in the compartment 306.

When the application calls a wrapper function 310, the wrapper function adds a permission to the compartment specification 302, so that the compartment specification 302 indicates that the resource request is permitted. For example, where the application makes a resource request that comprises a request to open a file in a read-only mode, the wrapper function 310 records a permission including the file name and the mode in the compartment specification 302. Therefore, the compartment specification 302 indicates that the application is permitted to open that file in read-only mode. If the application is subsequently executed in a secure compartment, the application cannot be used (for example, by a remote attacker), for example, to access files on a data processing system unless permission to access the files is provided in the compartment specification.

When the application 304 makes a resource request, it makes a call to a system function 312 with arguments that provide details of the resource request (for example, where the resource request is a request to open a file in a read-only mode, one argument may be the file name and another argument may be the mode). These arguments are passed to the wrapper function 310 when the wrapper function is called, and therefore the wrapper function is in possession of all of the details required to add a permission to the compartment specification 302.

The permission is recorded in the compartment specification in a manner that is appropriate for the compartmentalization software that will be used to execute the application 304 in a secure compartment. For example, where the compartmentalization software is Security Containment for the HP-UX operating system, the compartment specification is suitable for use with that compartmentalization software as indicated in “HP-UX 11i Security Containment Administrator's Guide”, http://www.docs.hp.com/en/5991-1821/5991-1821.pdf. Alternatively, where the compartmentalization software is Type Enforcement for the SELinux operating system, the compartment specification is suitable for use with that software as indicated in “Configuring the SELinux Policy: Policy Language and the Example Policy Configuration”, http://www.nsa.gov/selinux/papers/policy2/x107.html. The above references are incorporated herein in their entirety by reference for all purposes.

The compartment specification 302 may already contain a permission corresponding to a resource request, for example if the application 304 has previously made the same resource request. In this case, the wrapper function 310 may choose not to record the permission in the compartment specification 302.

Once the wrapper function 310 has recorded a new permission in the compartment specification 302, or has chosen not to record a new permission, the wrapper function calls the appropriate system function 312 such that the system function handles the resource request. The application 304 therefore executes with full functionality while the compartment specification 302 is being produced.

The application 304 is executed until the compartment specification is fully populated with permissions. The application 304 is therefore executed such that, while the compartment specification 302 is being produced, the application 304 requests all of the resources that would be used by the application 304. This may be done, for example, by causing the application 304 to execute all code paths. The application 304 may be provided with test functionality for the purposes of testing the application 304. This test functionality could be used to cause the application to execute all code paths and/or request all of the resources that would be used by the application 304. Thus, a complete compartment specification 302 is produced. However, in alternative embodiments, an incomplete compartment specification may be produced, and this may lead to reduced functionality of the application 304 when executing in a secure compartment.

Once the compartment specification 302 has been produced, the application 304 may be executed in a secure compartment according to the compartment specification 302 in a manner similar to that shown for the application 102 in FIG. 1. Therefore, the application 304 may not request resources that it did not request while the compartment specification 302 was being produced. The security of the application 304 and/or the data processing system on which it is executing may therefore be improved over the application 304 executing outside of a secure compartment.

Any application to be executed within a secure compartment may be associated with a compartment specification produced according to embodiments of the invention. For example, an Apache HTTP server application or BIND (Berkeley Internet Name Domain) DNS application may be executed in a secure compartment to prevent the application from being used to attack the data processing system on which it is executing, and/or any other resources or applications of the data processing system. The compartment specification produced using embodiments of the invention may be complete and does not contain errors as it records resource requests made by the application. Large and complex applications, such as enterprise applications, may be associated with large and complex compartment specifications produced using embodiments of the invention. A compartment specification produced according to embodiments of the invention may not require knowledge of the application and the data processing system on which it will execute, and the operating system of the data processing system.

Below is an example of a compartment specification produced using embodiments of the invention for an Apache web server application. The compartment specification has been produced such that it is usable with the Security Containment compartmentalization software. The compartment specification includes line numbers for the purposes of explanation, although the compartment specification may or may not include the line numbers.

| 01 compartment Apache { | |
|---|---|
| 02 permission read | /opt/hpws/apache |
| 03 permission write | /opt/hpws/apache/logs |
| 04 permission all | /var/tmp |
| 05 permission all | /tmp |
| 06 permission all | /dev/null |
| 07 | |

| | |
|---|---|
| 08 access fifo | init |
| 09 access uxsock | init |
| 10 access ipc | web |
| 11 | |

| | |
|---|---|
| 12 grant bidir tcp | port 80 ifaces |
| 13 grant bidir udp | peer port 80 ifaces |
| 14 } | |

Line 01 gives a name to the compartment. In the above compartment specification, the compartment is given the name “Apache”.

Line 02 of the above example compartment specification allows the Apache web server application to read files from the /opt/hpws/apache directory when the Apache application is executing in a secure compartment. This line would have been added to the compartment specification while the compartment specification was being produced according to embodiments of the invention. Embodiments of the invention may allow access to all files in a directory that was accessed during creation of the compartment specification, although in alternative embodiments access may be given for only specific files accessed by the application during creation of the compartment specification.

Line 03 allows the application to write to the /opt/hpws/apache/logs file. Line 04 allows the application all permissions (for example, read, write, create, unlink and search permissions) for the /var/tmp directory. Line 05 allows the application all permissions for the /tmp directory. Line 06 allows the application all permissions for the /dev/null directory. Embodiments of the invention may, for example, automatically add certain permissions to the compartment specification, such as, for example, all permissions for the /tmp temporary files directory, although in other embodiments, access may not be automatically given.

Lines 08 and 09 allow the application to access the fifo and uxsock processes/applications that are executing in or are present in the compartment named “init”. Line 10 allows the application to access the ipc process/application that is executing in or is present in the compartment named “web”.

Line 12 allows the application to both send and receive (due to the presence of “bidir”) TCP protocol packets over port number 80 using processes/applications that are executing in or are present in the compartment named “ifaces” and/or using interfaces that belong to the “ifaces” compartment. Line 13 allows the application to send and receive UDP protocol packets over peer port number 80 using processes/applications that are executing in or are present in the compartment named “ifaces” and/or using interfaces that belong to the “ifaces” compartment.

FIG. 4 shows a data processing system 400 suitable for use with implementations of embodiments of the invention. The data processing system 400 includes a data processor 402 and a memory 404. The system 400 may also include a permanent storage device 406 such as a hard disk, and/or a network communications device for communicating with an external wired and/or wireless network such as, for example, a LAN, WAN or internet. The system 400 may also include a display device 410 and/or an input device 412 such as a mouse and/or keyboard.

A data processing system and/or an operating system on the data processing system may be changed to include new system functions for handling resources. In this case, where an application makes a resource request using a new system function when a compartment specification is being produced, a wrapper function will not be called in place of the system function as an appropriate wrapper function would not be available. This may lead to limited functionality of the application when executing in a secure compartment, as the resource requests using the new system functions would not be permitted by the compartment specification. Embodiments of the invention may be easily enhanced by providing a new wrapper library that includes wrapper functions corresponding to the new system functions. Therefore, a complete compartment specification may be produced using the new wrapper library. No system functions need to be patched, and a computer program implementing embodiments of the invention does not need to be patched, to update the wrapper library to include more wrapper functions.

Embodiments of the invention may be used, for example, by an application's developers or during installation or maintenance of the application to produce a compartment specification for the application. In other embodiments of the invention, for example, a system administrator or person installing or maintaining the application on a system may use embodiments of the invention to produce the compartment specification.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of producing a compartment specification for an application, comprising:
executing the application;
determining resource requests made by the executing application; and
recording the resource requests in the compartment specification.

2. A method as claimed in claim 1, wherein determining the resource requests comprises trapping the resource requests made by the executing application.

3. A method as claimed in claim 2, wherein trapping the resource requests comprises defining wrapper functions that are called when the executing application makes a resource request.

4. A method as claimed in claim 3, wherein the wrapper functions are provided in a wrapper library.

5. A method as claimed in claim 3, wherein the wrapper functions call associated system functions that handle the resource requests.

6. A method as claimed in claim 1, wherein executing the application comprises executing the application in a compartment that allows access to at least all resources required by the application.

7. A method as claimed in claim 6, wherein the compartment allows access to all resources.

8. A method as claimed in claim 1, comprising executing the application in a compartment according to the compartment specification such that resource requests other than those recorded in the compartment specification are unsuccessful.

9. A computer program for producing a compartment specification for an application, comprising:
code for executing the application;
code for determining resource requests made by the executing application; and
code for recording the resource requests in the compartment specification.

10. A computer program as claimed in claim 9, wherein the code for determining the resource requests comprises code for trapping the resource requests made by the executing application.

11. A computer program as claimed in claim 10, wherein the code for trapping the resource requests comprises wrapper functions that are called when the executing application makes a resource request.

12. A computer program as claimed in claim 11, wherein the wrapper functions are provided in a wrapper library.

13. A computer program as claimed in claim 11, wherein the wrapper functions call associated system functions that handle the resource requests.

14. A computer program as claimed in claim 9, wherein the code for executing the application comprises code for executing the application in a compartment that allows access to at least all resources required by the application.

15. A computer program as claimed in claim 14, wherein the compartment allows access to all resources.

16. A computer program as claimed in claim 1, comprising code for executing the application in a compartment according to the compartment specification such that resource requests other than those recorded in the compartment specification are unsuccessful.

17. A system for implementing the method as claimed in claim 1.

18. A data processing system having loaded therein a computer program as claimed in claim 9.

19. Computer readable storage storing a computer program as claimed in claim 9.
